(19) United States
(12) Patent Application Publication
(10) Pub. No.: US 2011/0011373 A1
(43) Pub. Date: Jan. 20, 2011

(54) FUEL SUPPLY DEVICE

(75) Inventors: Takeshi Shimura, Wako-shi (JP); Tomoyuki Tagami, Wako-shi (JP); Takashi Udono, Wako-shi (JP); Mitsuo Kusa, Wako-shi (JP); Akihiro Nakamaru, Wako-shi (JP); Masaki Ueno, Wako-shi (JP); Yuji Kashiwabara, Wako-shi (JP)

Correspondence Address: BIRCH STEWART KOLASCH & BIRCH, PO BOX 747, FALLS CHURCH, VA, 22040-0747, US

(73) Assignee: HONDA MOTORS CO., LTD.

(21) Appl. No.: 12/922,375

(22) PCT Filed: Feb. 18, 2009
(86) PCT No.: PCT/JP2009/052781

§ 371 Date: Sep. 13, 2010

(30) Foreign Application Priority Data
Mar. 31, 2008 (JP) 2008-094400
Sep. 17, 2008 (JP) 2008-238728

(51) Int. Cl. F02M 37/04

(52) U.S. Cl. 123/497

(57) ABSTRACT

An inexpensive fuel supply device having a high output is achieved using low-output fuel pumps.

First and second pumps, which are two inexpensive pumps having a low output, are disposed on a common mounting seat an inlet of each of the fuel pumps approaches a common fuel filter, discharge ports are connected to a common discharge passage so that the amount of fuel corresponding to the sum of the amounts of discharged fuel of the fuel pumps can be supplied from the common discharge passage, a common pressure regulator is connected to the common discharge passage, and the entire structure is formed as a unit, thereby obtaining an inexpensive pump unit having a high output.

### BACKGROUND OF THE INVENTION

1. Field of the Invention

The present invention relates to a fuel supply device of a fuel injection apparatus of a motorcycle or the like, and more particularly, to a fuel supply device that can achieve a large-capacity pump at a low cost.

2. Description of the Related Art

A fuel supply device for an injector (fuel injection valve) of a fuel injection apparatus has used a fuel pump of which the output corresponds to the output of an engine (refer to Patent Document 1). Further, there has been known a fuel supply device that uses a plurality of fuel pumps in a fuel tank and feeds fuel to a fuel reserving part with pressure (refer to Patent Document 2). Furthermore, there has also been a fuel supply device where a large-sized fuel pump having a large amount of discharged fuel is formed using a plurality of existing fuel pumps (refer to Patent Document 3).

[Patent Document 1] JP 2006-315681 A

[Patent Document 2] JP 61-111884 U

[Patent Document 3] JP 2007-321583 A

When a fuel pump of which the output varies in accordance with the output of an engine is used, a high-output fuel pump should be used for a high-output engine, which increases cost. Accordingly, even in this case, it is desirable that a low-output fuel pump having versatility be used.

Further, when a pump having a large flow rate is employed to secure the amount of discharged fuel that is needed at the time of a high load such as the full open of a throttle, a lot of discharged fuel in a low-load range becomes return fuel of the regulator that is returned to the fuel tank from the pressure regulator. For this reason, since electric power corresponding to this is unnecessarily consumed, it is also desirable to reduce an electric load by securing a necessary amount of discharged fuel when needed.

Meanwhile, a plurality of fuel pumps is provided in divided tanks, respectively, only to reduce the amount of unavailable fuel remaining in divided tanks. Accordingly, the plurality of fuel pumps does not increase the output of the pump and causes the cost to increase in proportion to the number of the fuel pumps to be used.

Further, if a plurality of fuel pumps is combined so as to function as a large-sized fuel pump having a large amount of discharged fuel, a new single large-sized fuel pump does not need to be designed by using a plurality of known fuel pumps. Therefore, it is possible to simply and inexpensively obtain a fuel pump having high performance. However, the existing fuel pumps are merely combined and controlled in common so as to function as one fuel pump in accordance with the amount of discharged fuel to be desired. Therefore the fuel pumps are independently provided with a fuel filter or housing like in the past, and the cost or the number of components of the entire fuel pumps, which are newly combined, is simply proportional to the number of fuel pumps. Further, since the fuel pumps merely form an assembly, the size of the entire device cannot but be larger than the sum of the sizes of the fuel pumps. For this reason, it is desirable that the cost or the number of components be reduced and the device becomes compact.

An object of the present invention is to respond to the above-mentioned request.

### SUMMARY OF THE INVENTION

In order to address the above-mentioned problem, the present invention of claim 1 is directed to a fuel supply device that supplies fuel to an engine by a fuel pump disposed in a fuel tank wherein the fuel supply device includes a plurality of fuel pumps, and an inlet port of each of the fuel pumps is connected to a common fuel filter.

The invention of claim 2 is directed to the fuel supply device according to claim 1, further, a discharge port of each of the fuel pumps may be connected to a common discharge passage, and one pressure regulator may be disposed on the common discharge passage.

The invention of claim 3 is directed to the fuel supply device according to claim 1 or 2, further, the plurality of fuel pumps may be integrated into a common mounting seat that is mounted on a bottom portion of the fuel tank, thereby forming a single pump unit.

The invention of claim 4 is directed to the fuel supply device according to claim 3, further, the pump unit may include one pressure regulator and one fuel filter common to the fuel pumps.

The invention of claim 5 is directed to the fuel supply device according to any one of claims 1 to 4, further, fuel may be supplied to a plurality of injectors from the pump unit.

The invention of claim 6 is directed to the fuel supply device according to claim 3, the fuel pumps of the pump unit each may have a cylindrical shape, may be disposed in parallel so that axes of the fuel pumps are parallel to each other, and may be fixed to the mounting seat.

The invention of claim 7 is directed to a fuel supply device that supplies fuel to an engine by a fuel pump disposed in a fuel tank, in which the fuel supply device includes a plurality of fuel pumps, and the plurality of fuel pumps includes first and second fuel pumps that have relatively different amount of discharged fuel and electric power consumption. Further, in accordance with operating conditions of the engine, an operating state is switched to any one of: a first operating state where the first fuel pump is operated and the second fuel pump is rested to supply fuel to the engine; a second operating state where the second fuel pump is operated and the first fuel pump is rested to supply fuel to the engine; and a third operating state where the first and second fuel pumps are operated to supply fuel to the engine, so that fuel is supplied to the engine.

The invention of claim 8 is directed to the fuel supply device according to claim 7, further, the first and second fuel pumps of the pump unit each are shaped cylindrical, are disposed in parallel so that axes of the fuel pumps are parallel to each other, and are fixed and integrated to a common mounting seat, thereby forming a single pump unit. Further, the mounting seat is detachably mounted on a bottom portion of the fuel tank.

According to the invention of claim 1, since a plurality of fuel pumps is used, it is possible to obtain a high output corresponding to the number of the fuel pumps to be used. Further, since the inlets are connected to the common fuel filter, the fuel filter is shared so that only one fuel filter is used. As a result, even though a fuel supply device has a high-output as a whole, it is possible to reduce the cost and the number of components by the sharing of components and to easily provide a device in a common fuel tank by making the pump unit be compact.

According to the invention of claim 2, the discharge port of each of the fuel pumps is connected to the common discharge passage and the pressure regulator is shared. Therefore, it is possible to obtain the same effect as claim 1.

According to the invention of claim 3, since the plurality of fuel pumps is integrated into the common mounting seat that is mounted on a bottom portion of the fuel tank, it is possible to form the fuel pumps as a unit. Further, since the pump unit is easily attached or detached to or from the fuel tank and functions as one high-output fuel pump, it is possible to obtain an inexpensive fuel supply device having a high output.

According to the invention of claim 4, since the fuel pumps are formed as a unit and share the fuel filter and the pressure regulator, it is possible to make the pump unit be compact at the lowest cost.

According to the invention of claim 5, since a high output is obtained due to the plurality of fuel pumps even though fuel is supplied to the plurality of injectors from the pump unit, it is possible to supply sufficient fuel to each of the injectors. In addition, since each of the fuel pumps of the pump unit may be a low-output fuel pump having versatility, the fuel supply device is advantageous for the plurality of injectors.

According to the invention of claim 6, the fuel pumps of the pump unit each have a cylindrical shape, are disposed in parallel so that axes of the fuel pumps are parallel to each other, and are fixed to the mounting seat. Therefore, it is possible to make the pump unit be more compact.

According to the invention of claim 7, a fuel supply device is provided with the plurality of fuel pumps that includes first and second fuel pumps having different amount of discharged fuel and electric power consumption. Accordingly, in accordance with operating conditions of the engine, it is possible to switch an operating state to any one of a first operating state where the first fuel pump is operated and the second fuel pump is rested, a second operating state where the second fuel pump is operated and the first fuel pump is rested, and a third operating state where the first and second fuel pumps are operated. For this reason, it is possible to stepwise supply fuel in accordance with the operating state of the engine by simple control, that is, only the combination of the operation or stop of the pumps, and to change the entire amount of discharged fuel stepwise without performing complicated control.

In addition, since it is possible to change electric power consumption into an optimal state in accordance with the operating conditions by the combination of the pumps having different electric power consumption, it is possible to reduce an electric load by securing a necessary amount of discharged fuel when needed. For this reason, it is possible to suppress electric power consumption, to reduce the size of a generator, and to improve fuel efficiency.

According to the invention of claim 8, the first and second fuel pumps each have a cylindrical shape, are disposed in parallel so that axes of the fuel pumps are parallel to each other, and are integrated to a common mounting seat that is mounted on the bottom portion of the fuel tank, thereby forming a single pump unit. Therefore, the pump unit is easily attached or detached to or from the fuel tank.

Further, while being close to each other, the fuel pumps can be fixed to the common mounting seat. Therefore, it is possible to make the pump unit be more compact.

### BRIEF DESCRIPTION OF THE DRAWINGS

FIG. 1 is a view showing a fuel supply device of a motorcycle to which the present invention is applied;

FIG. 2 is a schematic diagram of a fuel supply system;

FIG. 3 is a perspective view of a pump unit;

FIG. 4 is a plan view of the pump unit;

FIG. 5 is a cross-sectional view taken along line 5-5 of FIG. 4;

FIG. 6 is a cross-sectional view taken along line 6-6 of FIG. 5;

FIG. 7 is a side view of a motorcycle on which a V-type engine used in another embodiment is mounted;

FIG. 8 is a schematic view showing the fuel supply structure of the V-type engine in FIG. 7;

FIG. 9 is a view showing the structure of a fuel supply device according to a second embodiment;

FIG. 10 is a view showing the structure of a fuel supply device according to a third embodiment;

FIG. 11 is a schematic view showing the structure of a pump unit according to a fourth embodiment; and

FIG. 12 is a graph showing a relationship between the amount of discharged fuel regarding to electric power consumption of the pump unit and a load state of an engine.

### DETAILED DESCRIPTION OF THE PREFERRED EMBODIMENT

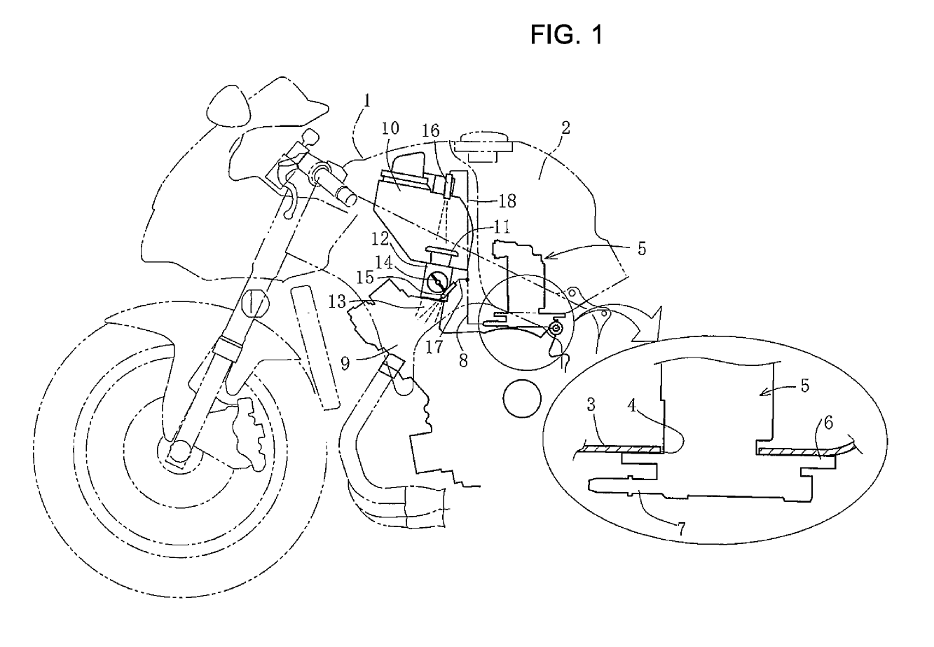

An embodiment will be described below with reference to drawings. FIG. 1 shows a fuel supply device of a motorcycle to which the present invention is applied. A vertically long fuel tank 2 is disposed at a rear half portion in a large-capacity tank cover 1, a pump unit 5 is inserted through an opening 4 that is formed at a bottom portion 3 of the fuel tank, and a flange-like mounting seat 6 is formed at the bottom portion 3, so that the pump is provided in the tank. A discharge pipe 7 is provided near the mounting seat 6, and fuel is supplied from the discharge pipe 7 to an intake unit of a forward-tilted engine 9, which is disposed on the front side of the fuel tank 2, through a fuel pipe 8. Meanwhile, the fuel pipe 8 is a pipe for high-pressure fuel like a fuel hose or a fuel tube as described below.

An air cleaner 10 is disposed at a front half portion in the tank cover 1 that forms the front side of the fuel tank 2, an intake pipe 11 is disposed in the air cleaner in a vertical direction, and a lower end of the intake pipe 11 is connected to a throttle body 12. The throttle body 12 is connected to an intake port 13 of the engine 9. The air cleaner 10 and the throttle body 12 forms the intake unit of the engine 9, and intake is performed toward the intake port 13 in a downdraft manner.

The throttle body 12 is provided with a throttle valve 14 and a first injector 15 provided on the downstream side of the throttle valve, so that fuel is injected into the intake port 13. A second injector 16 is provided at the top of the air cleaner 10 on an extension line of an axis of the intake pipe 11, which is the upstream side of the throttle valve 14, and injects fuel into the intake pipe 11. Fuel is supplied to the first injector 15 and the second injector 16 from branch connectors 17 and 18 that branch from the fuel pipe 8, respectively.

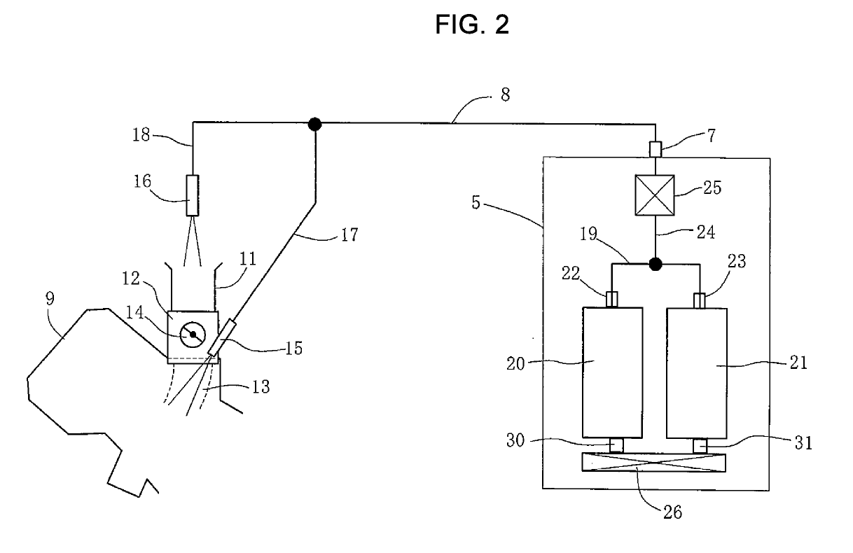

FIG. 2 schematically shows the fuel supply system. The pump unit 5 includes two fuel pumps that are composed of a first pump 20 and a second pump 21. Discharge ports 22 and 23 are connected to the fuel pumps, respectively, and connected to the discharge pipe 7 by a common discharge passage 24. A common pressure regulator 25 is connected to the common discharge passage 24. Further, the first pump 20 and the second pump 21 suck fuel through a common fuel filter 26. Supply paths from the pump unit 5 to injectors are as described above. Through the discharge pipe 7 and the fuel pipe 8, fuel is supplied from the branch connector 17 to the first injector 15 and fuel is supplied from the branch connector 18 to the second injector 16.

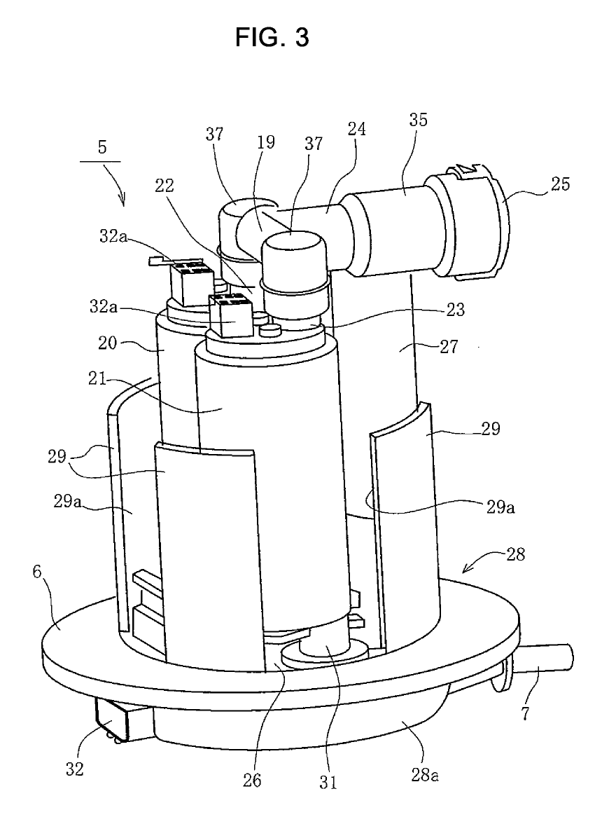

The pump unit 5 will be described in detail below. FIG. 3 is a perspective view of the pump unit 5. The pump unit 5 includes a single common unit case 28, a mounting seat 6 having the shape of an outer flange is integrally formed with a portion of the unit case near the bottom portion thereof, and a bottom portion 28a that is formed below the mounting seat 6 has substantially the shape of a cup. In the unit case 28, two fuel pumps, that is, the first and second pumps 20 and 21 each have a cylindrical shape, and are disposed in parallel so that axes of the fuel pumps are parallel to each other. The first and second pumps 20 and 21 are general-purpose products that are used as low-output products. In this embodiment, products having the same performance are used as the both fuel pumps. The fuel pumps are disposed parallel to each other so that the center axes of the fuel pumps are oriented in the vertical direction. The discharge ports 22 and 23, which are provided at the tops of the fuel pumps, are connected to the common discharge passage 24 by a joint pipe 19.

The common discharge passage 24 extends substantially horizontally and then communicates with a vertical part 27 that is disposed in a vertical direction, and the pressure regulator 25 is connected to a bent portion of the vertical part 27. The vertical part 27 forms a part of the common discharge passage 24.

The pressure regulator 25 is a unit that is opened when the pressure of the fuel discharged into the common discharge passage 24 becomes equal to or larger than a predetermined value and returns a part of the fuel to the fuel tank 2. Only one pressure regulator is provided on the common discharge passage 24. The fuel pressure controlled by the pressure regulator 25 is the fuel pressure of the common discharge passage 24, which corresponds to a large amount of fuel after the amounts of fuel discharged from the two discharge ports 22 and 23 are summed up. The pressure regulator adjusts the pressure of fuel corresponding to a high output.

The lower end of the vertical part 27 communicates with the discharge pipe 7 that passes through the bottom portion 28a of the unit case 28 and protrudes to the outside. The first and second pumps 20 and 21 are disposed inside surrounding walls 29 that protrude upward from the bottom portion 28a of the unit case 28, and are supported by the surrounding walls with appropriate means. The vertical part 27 is also the same as described above. The surrounding walls 29 correspond to walls including gaps 29a that are obtained by cutting out a part of a vertical wall surrounding the first and second pumps 20 and 21 and the vertical part 27 in an annular shape. The gaps 29a are formed to allow fuel, which is provided around the pump unit 5, to easily enter the bottom portion 28a of the unit case 28. In the bottom portion 28a of the unit case 28, an inlet port 31 protrudes from a lower end portion of the second pump 21, and a lower end of the inlet abuts on the upper surface of the fuel filter 26 (an inlet 30 is formed at the first pump 20 in the same manner as described above).

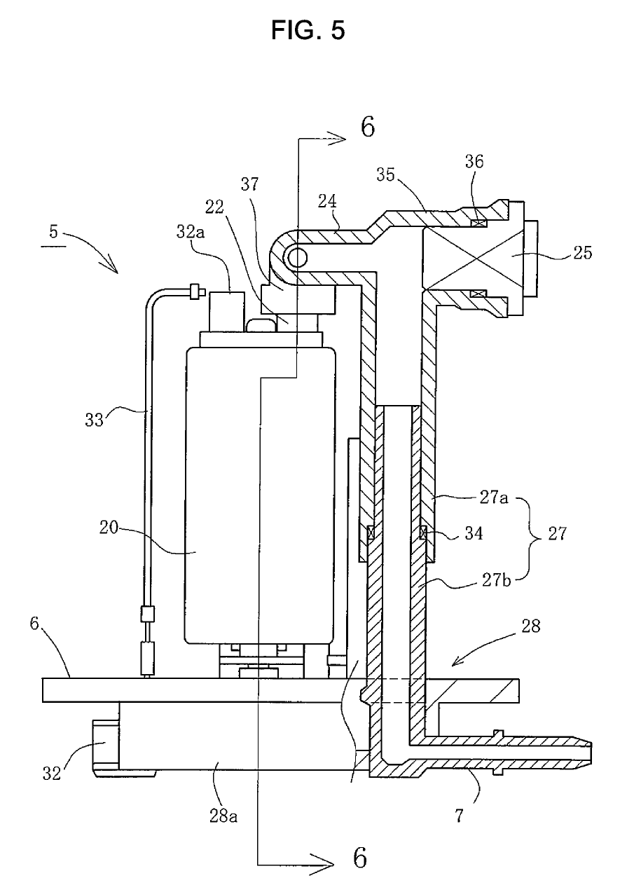

As described above, the pump unit 5 is a unit that is obtained by integrating the first and second pumps 20 and 21, the common discharge passage 24, the pressure regulator 25, and the fuel filter 26 into the unit case 28. The pump unit may be handled as one unit, and the mounting seat 6 may be detachably mounted on the bottom portion of the fuel tank 2 by bolts (not shown). Meanwhile, in the drawings, reference numeral 32 indicates an external connector that is provided outside the unit case 28, and reference numeral 32a indicates a pump connector that is provided on the upper surface of each of the fuel pumps. The pump connectors are connected to the external connector 32 by lead wires 33 (FIG. 5), and can control the drive of each of the fuel pumps by an ECU (not shown). Various vehicle data, which are required to control the drive of the fuel pump, are collected to the ECU.

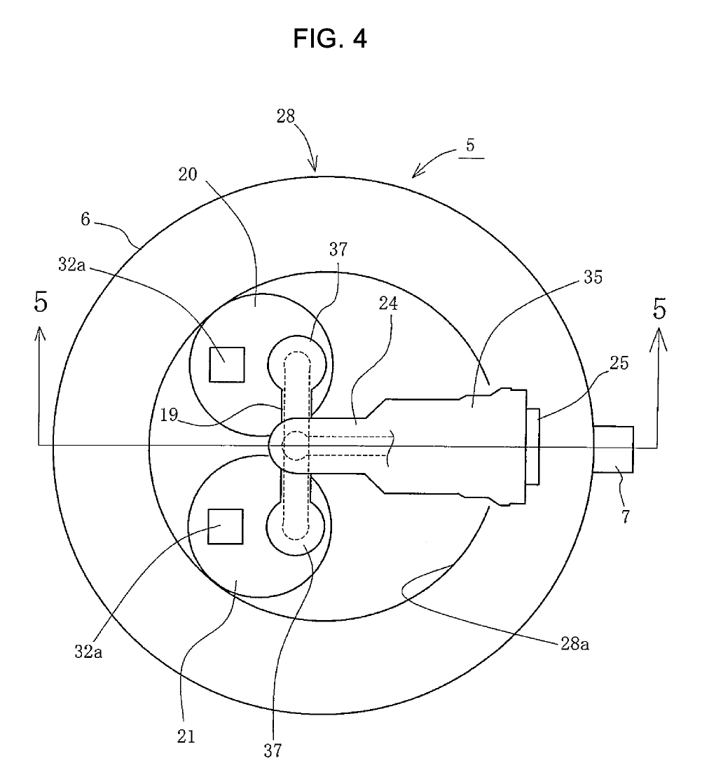

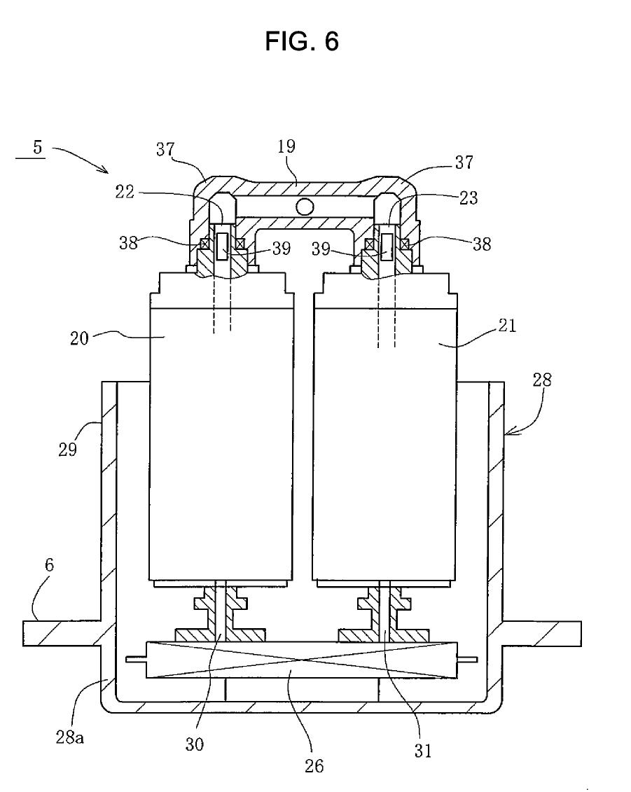

FIG. 4 is a plan view of the pump unit 5, FIG. 5 is a cross-sectional view taken along line 5-5 of FIG. 4, and FIG. 6 is a cross-sectional view taken along line 6-6 taken along line of FIG. 5. As apparent from FIG. 4, the common discharge passage 24 and the joint pipe 19 form a T shape, and the first and second pumps 20 and 21 are disposed in parallel on the right and left sides of the axis of the common discharge passage 24.

In FIG. 5, the vertical part 27 is divided into an upper pipe 27a and a lower pipe 27b at a middle portion in a vertical direction, and the lower pipe is fitted into the upper pipe so that the lower and upper pipes are integrated. A seal 34 is provided at a fitted portion. A common discharge passage 24 that extends inward in a horizontal direction and a socket portion 35 that is opened and extends outward are formed at an upper end of the upper pipe 27a. The socket portion 35 communicates with the common discharge passage 24 and the upper pipe 27a, and the pressure regulator 25 is fitted to the socket portion with a seal 36 interposed therebetween.

A lower portion of the lower pipe 27b passes through the bottom portion 28a of the unit case 28, is bent in a horizontal direction, and extends outward in a radial direction. The lower portion forms the discharge pipe 7.

In FIG. 6, the fuel filter 26, which is common to the first and second pumps 20 and 21, is received in the bottom portion 28a of the unit case 28, and the inlet 30 of the first pump 20 and the inlet port 31 of the second pump 21 are in close contact with the upper surface of the fuel filter. Since the fuel filter 26 is commonly used for the first and second pumps 20 and 21, the fuel filter has a capacity that is equal to or larger than the sum of the required capacities of the fuel pumps. The upper surface of the fuel filter 26 has been supported by the inlet ports 30 and 31, but may be fixed to the bottom portion of the unit case 28 by other appropriate fixing means if necessary.

The joint pipe 19, which is connected to the discharge ports 22 and 23, is provided with caps 37 at both ends thereof in a longitudinal direction. The caps cover the discharge ports 22 and 23, so that the joint pipe is easily connected to the discharge ports. A seal 38 is provided at a fitted portion.

The operation of the embodiment will be described below. As shown in FIG. 1, the fuel pumps of the pump unit 5 are inserted into the fuel tank 2 and the mounting seat 6 is fixed to the bottom portion 3 of the fuel tank 2 by bolts or the like, so that the pump unit is fixed to the fuel tank 2. If the pump unit 5 is driven in this state, the first and second pumps 20 and 21 simultaneously suck the fuel of the fuel tank 2 from the bottom portion 28a of the unit case 28 through the fuel filter 26, discharge the fuel through the discharge ports 22 and 23, mix the fuel fed from the fuel pumps at the discharge passage 24, and supply the fuel to the first and second injectors 15 and 16 while the pressure regulator 25 adjusts pressure.

In this case, since the fuel, which is supplied from the pump unit 5, should be simultaneously supplied to two positions, that is, the first and second injectors 15 and 16, a large amount of fuel is required. However, sufficient fuel corresponding to the amount of fuel, which is supplied from the high-output fuel pump in the related art, can be supplied by two fuel pumps, that is, the first and second pumps 20 and 21. Accordingly, it is possible to easily supply a large amount of fuel. In addition, each of the first and second pumps 20 and 21 of the pump unit 5 is a low-output fuel pump that cannot output a high output. Since the low-output fuel pump has versatility and is relatively inexpensive, the sum of the costs of two pumps is lower than the cost of one high-output fuel pump that corresponds to the sum of the outputs of the two low-output fuel pumps. Therefore, the pump unit of the present invention has high performance at a low cost.

Further, the two pumps, that is, the first and second pumps 20 and 21 form the pump unit 5. Accordingly, it is possible to easily attach or detach the pump unit to or from the fuel tank 2 by attaching or detaching the mounting seat 6 to or from the bottom portion 3 of the fuel tank 2 by bolts, and to easily handle the pump unit like a pump unit that is formed of a single high-output fuel pump. Furthermore, the common discharge passage 24 (including the vertical part 27), the pressure regulator 25, the fuel filter 26, and the like are used in common. Accordingly, since parts are used in common, even though the fuel supply device is formed of a plurality of fuel pumps and has a high-output, it is possible to make the fuel supply device be compact and to reduce cost.

Further, the first and second pumps 20 and 21 of the pump unit 5 each have a cylindrical shape, are disposed in parallel so that the axes of the pumps are parallel to each other, and are fixed to the common unit case 28. Therefore, it is possible to make the pump unit 5 be more compact.

In addition, since each of the fuel pumps may be a low-output pump, the fuel pump has versatility, which may contribute to cost-reduction.

Meanwhile, the present invention is not limited to the above-mentioned embodiment, and may have various modifications and applications within the principle of the present invention. For example, as long as two or more fuel pumps are used, the number of fuel pumps is unnecessary to be considered. The number of the fuel pumps may be determined in consideration of the required performance, the sum of the costs of the fuel pumps that are general-purpose products to be used, and the allowable size of the formed unit.

Further, the sharing of parts may be applied to any one of the pressure regulator 25 and the fuel filter 26.

In addition, fuel may be simultaneously supplied to the plurality of injectors like in the embodiment. In contrast, fuel may be supplied only to one injector.

As for the plurality of fuel pumps, fuel pumps having the same output may be combined with each other or fuel pumps having different outputs may be combined with each other.

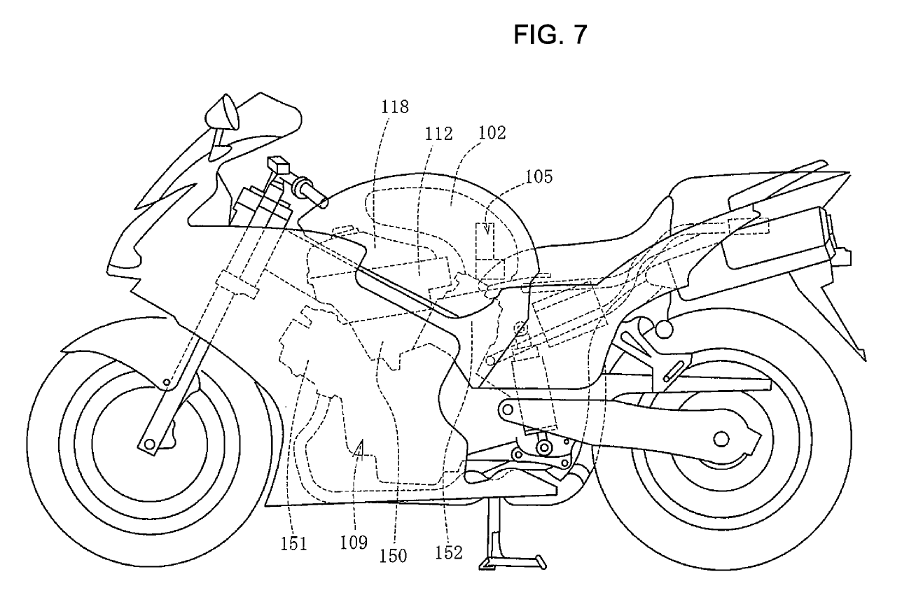

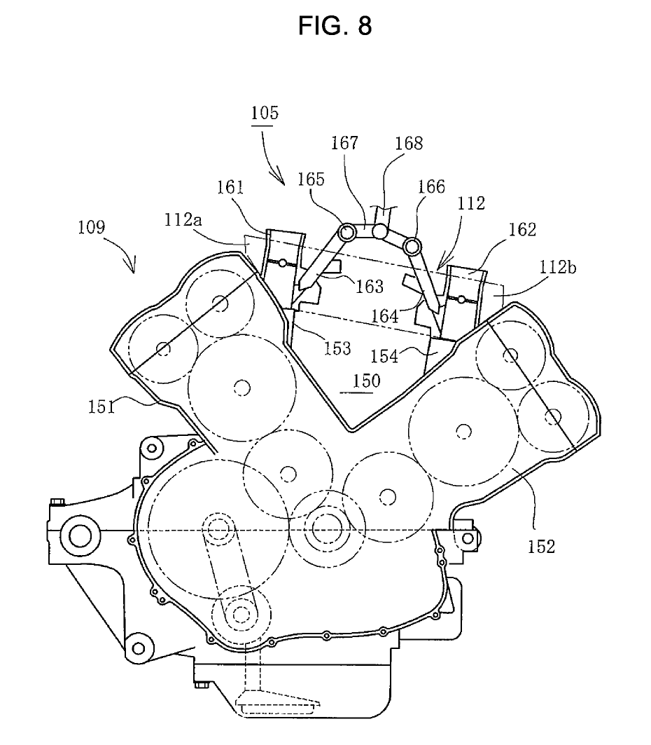

Another embodiment applied to a V-type multi-cylinder engine will be described below. FIG. 7 is a side view of a motorcycle on which a V-type multi-cylinder engine 109 is mounted, and FIG. 8 is a schematic cross-sectional view of an intake structure of the V-type multi-cylinder engine 109. In these drawings, a fuel tank 102 and an air cleaner 118 are provided above the V-type multi-cylinder engine 109, the air cleaner 118 is positioned above a V bank 150 of the V-type multi-cylinder engine 109, and a throttle body 112 is disposed in the V bank 150 that is positioned below the air cleaner 118.

A pump unit 105 is received in the fuel tank 102, and fuel is supplied to front and rear banks 151 and 152 from the pump unit 105.

As shown in FIG. 8, the V bank 150 forms a substantially V-shaped space, which is interposed between the front bank 151 inclined forward and the rear bank 152 inclined rearward, in side view. Intake passages 153 and 154 are provided at the front and ear banks 151 and 152 so as to approach the V bank 150, respectively, and are connected to the throttle body 112. The number of the intake passages 153 and 154 corresponds to the number of cylinders, and two intake passages are provided at each of the front and rear banks 151 and 152 in this embodiment.

The throttle body 112 is mounted from the upper side of the V bank 150. The throttle body includes a front throttle body 112a that is connected to the intake passages 153 of the front bank 151, and a rear throttle body 112b that is connected to the intake passages 154 of the rear bank 152. Each of the front and rear throttle bodies 112a and 112b is also a small throttle body. The throttle body 112 is an assembly of these small throttle bodies. The number of the small throttle bodies is arbitrarily determined depending on the form of the engine or the number of cylinders.

The front throttle body 112a includes intake pipes 161 and injectors 163 of which the numbers correspond to the number of the intake passages that are objects to be mounted. In this embodiment, the front throttle body includes two intake pipes and two injectors. While one intake pipe 161 and one injector 163 make a pair, the intake pipes and the injectors are connected to the two intake passages 153 that are provided at the front bank 151. Likewise, the rear throttle body 112b includes two intake pipes 162 and two injectors 164, and the intake pipes and the injectors are connected to the two intake passages 154 that are provided at the rear bank 152. Meanwhile, the numbers of the intake pipes and the injectors are increased or decreased in accordance with the number of cylinders.

A first delivery pipe 165 is connected to the injector 163 corresponding to the intake passage 153, and a second delivery pipe 166 is connected to the injector 164 corresponding to the intake passage 154. The first and second delivery pipes 165 and 166 are disposed parallel to each other with a gap therebetween, are connected to a fuel hose 168 through a branch connector 167, are supplied with high-pressure fuel from the pump unit 105, inject fuel into the intake passages 153 and 154 through the injectors.

Meanwhile, the following fact has been known. That is, as the discharge pressure of the fuel is increased, the size of the atomized particle of the fuel injected through the injectors is decreased, which is excellent in starting performance.

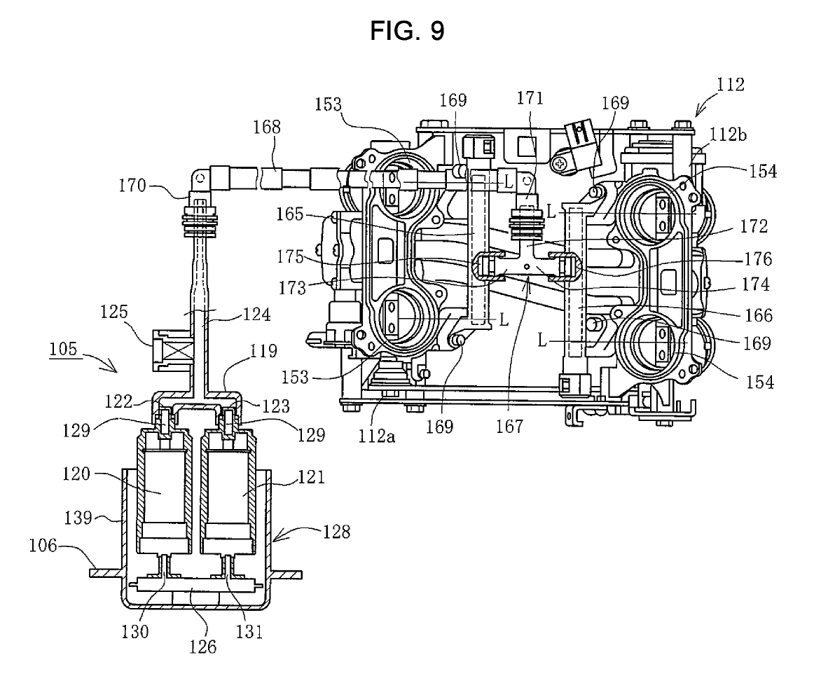

FIG. 9 is a view showing the structure of a fuel supply device according to a second embodiment that is used in the V-type multi-cylinder engine 109. First, the throttle body 112 will be described. The throttle body 112 is connected to the pump unit 105 through the fuel hose 168. First and second connectors 170 and 171 are provided at both ends of the fuel hose 168, and the fuel hose 168 is connected to the pump unit 105 through the first connector 170 and connected to an assembling part 172 of the branch connector 167 through the second connector 171. The branch connector 167 has a substantially T shape, and is fitted and connected to a socket 175, which is provided at a middle portion of the first delivery pipe 165 in a longitudinal direction, at one branch 173 of branches that branch from the assembling part 172 toward left and right sides.

The injectors 163 (see FIG. 9, meanwhile, although the injectors are not shown in this drawing because being disposed below the first delivery pipe 165, the mount positions of the injectors are shown by mounting lines L) are connected to both ends of the first delivery pipe 165, and fuel is supplied to the injectors 163 from the first delivery pipe 165. The other branch 174 of the branch connector 167 is fitted and connected to a socket 176, which is provided at a middle portion of the second delivery pipe 166 in a longitudinal direction.

The injectors 164 (see FIG. 9, meanwhile, although the injectors are not shown in this drawing because being disposed below the second delivery pipe 166, the mount positions of the injectors are shown by mounting lines L) are also connected to the second delivery pipe 166. The first and second delivery pipes 165 and 166 are fixed to the cases of the front and rear throttle bodies 112a and 112b at both ends thereof in the longitudinal direction by bolts 169. Each of the injectors is controlled by an ECU (not shown) so as to inject fuel only for a predetermined time. Accordingly, the injectors accurately inject an appropriate amount of fuel into the intake passages.

Next, the pump unit 105 will be described. The pump unit 105 is the same as the pump unit of the previous embodiment, and a unit that is obtained by integrating first and second pumps 120 and 121 having the same performance into a common unit case 128. Considering simple calculation, the pump unit is made to obtain twice as large amount of discharged fuel as the amount of fuel discharged from the pump by simultaneously driving the first and second pumps 120 and 121. A fuel filter 126 provided in the unit case 128 and a pressure regulator 125 provided at a common discharge passage 124 are shared and the components of the fuel filter and the pressure regulator are the same as those of the previous embodiment. Accordingly, the detailed description thereof will be omitted. Meanwhile, in the drawings, reference numerals 122 and 123 indicate discharge ports. The discharge ports are connected to a joint pipe 119 through back-flow prevention check valves 129 that are provided at the discharge ports, respectively, and the first and second pumps 120 and 121 are disposed so as to be connected to each other in parallel. Reference numerals 130 and 131 indicate inlets. Accordingly, it is possible to obtain twice as large amount of discharged fuel as compared to the amount of discharged fuel when the fuel pumps are individually used, and to appropriately and uniformly supply sufficient fuel to the front bank 151 and the rear bank 152.

The common discharge passage 124 is connected to one end of the fuel hose 168 through the first connector 170, the other end of the fuel hose 168 is connected to the branch connector 167 having a T shape through the second connector 171, and the branch connector 167 communicates with and is connected to the first and second delivery pipes 165 and 166 that are provided on the left and right sides of the branch connector. The branch connector 167 is positioned in the middle, that is, between the first and second delivery pipes 165 and 166 that are provided on the left and right sides of the branch connector, which makes it possible to form simple pipe structure. A connector, which is expensive and requires care for connection, may be composed of only two connectors, that is, the first and second connectors 170 and 171.

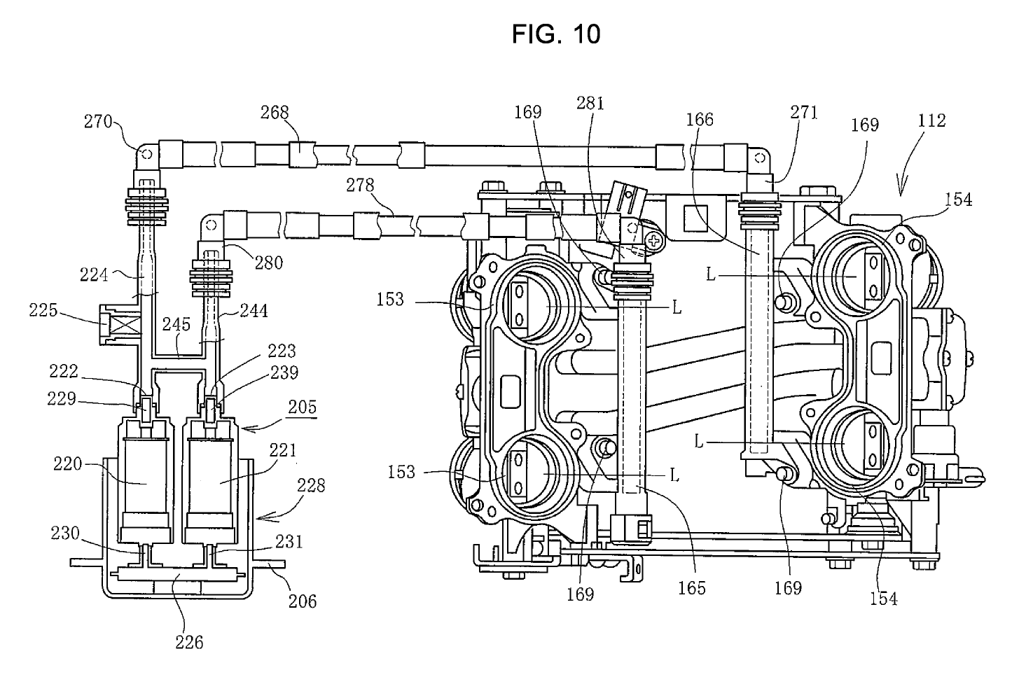

FIG. 10 shows a third embodiment that forms fuel supply structure for a V-type engine different from the fuel supply device shown in FIG. 9. In this embodiment, a pump unit 205 is a unit obtained by integrating two pumps, which are composed of first and second pumps 220 and 221 having the same performance, into a unit case 228. The first pump 220 is appropriately controlled so as to be turned on or off in accordance with operating conditions of the engine, and the second pump 221 is always driven. Further, first and second discharge passages 224 and 244, which are separate discharge passages, are provided for the first and second pumps 220 and 221, respectively. The first and second discharge passages 224 and 244 communicate with each other by a communicating pipe 245, and the first discharge passage 224 joins the second discharge passage 244 at the communicating pipe 245.

Further, the first and second discharge passages 224 and 244 independently extend from the joining portion, and are connected to independent first and second fuel hoses 268 and 278, respectively. The first discharge passage 224 is connected to one end of the first fuel hose 268 by a first connector 270, and the other end of the first fuel hose 268 is connected to one end of the second delivery pipe 166 by a second connector 271. The second discharge passage 244 is connected to one end of the second fuel hose 278 by a third connector 280, and the other end of the second fuel hose 278 is connected to an end of the first delivery pipe 165 by a fourth connector 281. Furthermore, a pressure regulator 225 is provided only on the first discharge passage 224 on the downstream side of the joining portion, and is shared without providing a pressure regulator on the second discharge passage 244. Therefore, the number of pressure regulators to be used is reduced.

Since a throttle body is the same as throttle body 112 of the previous embodiment except for fuel pipe structure, the same portions are represented by the same reference numerals. That is, in this embodiment, first and second delivery pipes 165 and 166 are connected to independent second and first fuel hoses 278 and 268, respectively, and are independent of each other without being connected to each other by the branch connector unlike in the previous embodiment.

Two injectors are connected to the first delivery pipe 165 (although the injectors are not shown in this drawing because being disposed below the first delivery pipe 165, the mount positions of the injectors are shown by mounting lines L), and fuel is supplied to the connected injectors from the first delivery pipe 165.

Likewise, injectors are also connected to the second delivery pipe 166 (although the injectors are not shown in this drawing because being disposed below the second delivery pipe 166, the mount positions of the injectors are shown by mounting lines L), and fuel is supplied to the connected injectors from the second delivery pipe 166.

Meanwhile, an engine of this embodiment is an engine of which the number of cylinders is variable. The cylinders of the rear bank 152 (see FIG. 8) are resting cylinders, and are rested by stopping the operation of the injectors 164 (see FIG. 8). The injectors are controlled by an ECU (not shown) on the basis of various sensor information relating to traveling conditions and operating conditions of an engine, such as vehicle speed and acceleration, engine speed, and engine temperature. The time when the cylinders are rested is the general travel time when a high output or discharge pressure is required in the engine 109. When a high output or discharge pressure is not required for operation, that is, when a vehicle is started or accelerated, the resting cylinders are operated by operating the injectors. If this cylinder idling system is employed, it is possible to improve fuel efficiency.

The above-mentioned structure of the pump unit 205 is different from the structure of the pump unit of the previous embodiment, and other structure thereof is the same as that of the previous embodiment. The pump unit is a unit that includes a common unit case 228 and a fuel filter 226. Meanwhile, in the drawings, reference numerals 222 and 223 indicate discharge ports. The discharge ports are connected to first and second discharge passages 224 and 244 through back-flow prevention check valves 229 and 239, respectively. The discharge ports 222 and 223 communicate with each other by a communicating pipe 245. Therefore, first and second pumps 220 and 221 are disposed so as to be connected to each other in parallel. Reference numerals 230 and 231 indicate inlet ports.

The first pump 220 is operated only at a specific time, that is, when high discharge pressure is required for staring or when a large amount of fuel is required for the high output of an engine. The first pump is stopped at a general travel time when the cylinders of the rear bank are rested. The second pump 221 is always driven and supplies fuel to both the first and second fuel hoses 268 and 278 or only to the second fuel hose 278. The first pump 220 is controlled by an ECU (not shown) on the basis of various sensor information relating to traveling conditions and operating conditions of an engine, such as vehicle speed and acceleration, engine speed, and engine temperature.

If the first pump 220 is stopped, the second pump 221 supplies fuel to the first fuel hose 268 through the communicating pipe 245 and supplies fuel to the second fuel hose 278. In this case, if the cylinders of the rear bank are rested, the injectors 164 (FIG. 8) of the second delivery pipe 166 are stopped. Accordingly, the supply of fuel to the first fuel hose 268 is stopped, and fuel is supplied only to the injectors 163 (FIG. 8) of the first delivery pipe 165 from the second fuel hose 278, so that only the cylinders of the front bank 151 (FIG. 8) are operated.

Further, if the cylinders of the rear bank are not rested, the second pump 221 supplies dividingly the fuel to the first fuel hose 268 and to the second fuel hose 278 through the communicating pipe 245. Fuel is injected from the injectors of the first and second delivery pipes 165 and 166, so that all cylinders are operated. This state is the lowest-output state where the amount of fuel is minimum, and the second pump 221 is set to performance where fuel can be supplied to all cylinders.

If the first pump 220 is operated, the fuel of the first pump 220 is mainly supplied to the second delivery pipe 166 from the first fuel hose 268 and the fuel of the second pump 221 is mainly supplied to the first delivery pipe 165 from the second fuel hose 278. However, since the first and second fuel hoses communicate with each other through the communicating pipe 245, the discharge pressure of the fuel supplied to the first and second fuel hoses 268 and 278 is averaged. Therefore, fuel is uniformly injected from the injectors of the first and second delivery pipes 165 and 166.

If the first and second pumps 220 and 221 are simultaneously driven as described above, it is possible to increase the amount of discharged fuel and discharge pressure of fuel as compared to when fuel is supplied to all cylinders only by the second pump 221, and to increase the output of the engine. Further, since the particle size of the fuel to be supplied is decreased if the discharge pressure is increased, it is possible to improve starting performance.

Since one fuel pump (the first pump 220 in this embodiment) is intermittently operated as described above, the engine is suitable for a resting cylinder type. When the first pump 220 is stopped, it is possible to rest the cylinders of the rear bank 152. In this case, only the front bank 151 continues to be operated by the second pump 221, so that it is possible to improve fuel efficiency as a whole.

Further, it is possible to control the pumps so that two pumps are simultaneously operated or individually operated. Accordingly, one pump (the first pump 220 in this embodiment) is driven only when a large amount of fuel is required, and only the other pump (the second pump 221 in this embodiment) is driven in other cases, which makes it possible to save electric power and reduce noise and discharged heat.

Furthermore, the pump unit 205 is a variable capacity pump unit, which can change the amount of fuel to be supplied, as a whole. Accordingly, it is possible to achieve an expensive variable capacity pump unit at a low cost by simple structure.

In addition, the second fuel hose 278, the third connector 280, and the fourth connector 281 are further provided. In contrast, it is possible to omit the branch connector 167 of the previous embodiment and to omit the socket, which is provided at a middle portion of each of the first and second delivery pipes 165 and 166 in the longitudinal direction, thereby achieving simplification.

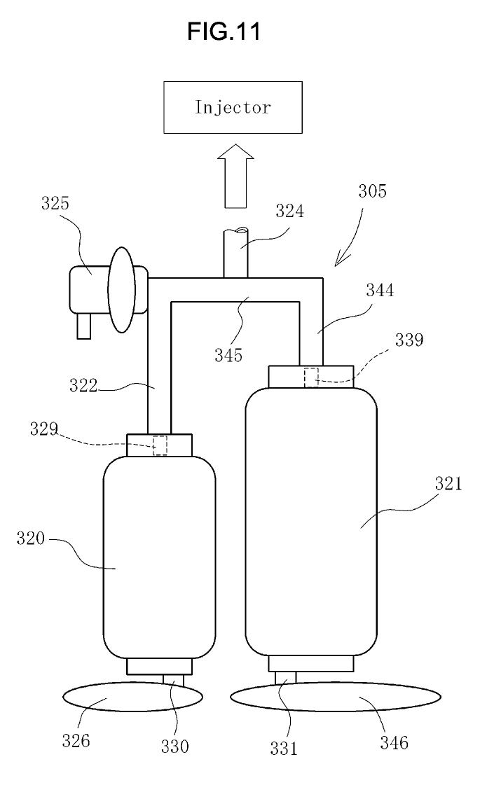

FIG. 11 schematically shows the structure of a pump unit 305 according to a fourth embodiment that is obtained by integrating a plurality of fuel pumps having different amount of discharged fuel and electric power consumption.

In this embodiment, a pump unit 305 is a unit where two pumps composed of first and second pumps 320 and 321 having the different performance are integrated.

The first pump 320 is a small pump of which the amount of discharged fuel and electric power consumption are suitable for the low-load operation of an engine. The second pump 321 is a pump of which the amount of discharged fuel and electric power consumption are relatively larger than those of the first pump 320 and suitable for the middle-load operation of an engine.

A first discharge passage 322 that extends from a discharge port 329 of the first pump 320 and a second discharge passage 344 that extends from a discharge port 339 of the second pump 321 are connected to a common discharge passage 324 through a communicating pipe 345. A pressure regulator 325 is provided at a connection portion between the first discharge passage 322 and the communicating pipe 345, and returns surplus fuel to a fuel tank as the return fuel of the regulator. The common discharge passage 324 is connected to a fuel pipe or a fuel hose, and supplies fuel to the injectors of the throttle body of the first or second embodiment.

Further, separated fuel filters 326 and 346 are provided at an inlet port 330 of the first pump 320 and an inlet port 331 of the second pump 321, respectively. The capacities of the fuel filters 326 and 346 are different from each other so as to correspond to the amount of discharged fuel of the fuel pumps. In this embodiment, the fuel filter 326 corresponding to the first pump 320 has a small capacity and the fuel filter 346 corresponding to the second pump 321 has a relatively large capacity.

The fuel filters 326 and 346 having different capacities and the first and second pumps 320 and 321 are assembled and integrated into the same common unit case (not shown) as that of each of the previous embodiments, thereby forming a unit. Further, the fuel filters and the first and second pumps function as a single variable capacity pump unit. Meanwhile, the first and second fuel pumps of the pump unit 305 each have a cylindrical shape like in the first embodiment and the like and are disposed in parallel so that the axes of the fuel pumps are parallel to each other. Accordingly, while being close to each other, the fuel pumps can be fixed to the common mounting seat (see FIG. 3). Therefore, it is possible to make the pump unit 305 be more compact. Furthermore, it is possible to easily attach or detach the fuel tank by mounting the mounting seat 6 on the bottom portion of the fuel tank 2 (see FIG. 1).

The first and second pumps 320 and 321 are controlled by an ECU (not shown) in accordance with the operating conditions of an engine. Accordingly, it is possible to switch an operating state to a first operating state where only the first pump 320 is operated and the second pump 321 is rested in a low-load state, a second operating state where the first pump 320 is rested and only the second pump 321 is operated in a middle-load state, and a third operating state where the first and second pumps 320 and 321 are simultaneously operated in a high-load state.

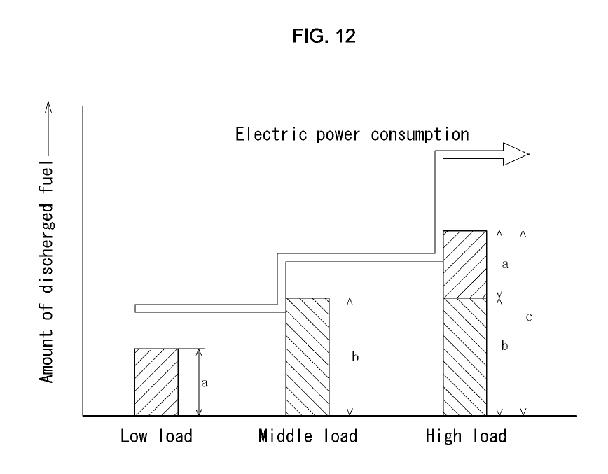

FIG. 12 is a graph showing a relationship between the amount of discharged fuel and electric power consumption of the pump unit 305 and a load state of an engine. The load state of the engine in a practical operation range is divided into a low-load state where a load is lowest, a high-load state such as a full throttle state where a load is highest, and a middle-load state that is intermediate between the low-load state and the high-load state. Assuming that the amount of discharged fuel required in the low-load state is “a”, the amount of discharged fuel required in the middle-load state is “b”, and the amount of discharged fuel required in the high-load state is “c”, the load state of the engine is set so that a relationship of “a+b=c” is satisfied. In addition, the amount “a” of discharged fuel, which is determined as described above is referred to as the amount of discharged fuel of the first pump 320, and the amount “b” of discharged fuel is referred to as the amount of discharged fuel of the second pump 321.

In this case, if only the first pump 320 is operated and the second pump 321 is stopped in the low-load state, the amount of discharged fuel of the pump unit 305 becomes “a” suitable for the low-load state. If the first pump 320 is rested and only the second pump 321 is operated in the middle-load state, the amount of discharged fuel of the pump unit 305 becomes “b” suitable for the middle-load state. If the first and second pumps 320 and 321 are simultaneously operated in the high-load state, the amount of discharged fuel of the pump unit 305 becomes “c” suitable for the high-load state.

Further, the electric power consumption of the first pump 320 having a small amount of discharged fuel is small, the electric power consumption of the second pump 321 having a larger amount of discharged fuel is larger, and the largest electric power consumption obtained from the sum of the electric power consumption of the first and second pumps 320 and 321 corresponds to the high-load state.

Accordingly, as shown in FIG. 12, the amount of discharged fuel is increased stepwise in order of the low-load state, the middle-load state, and the high-load state. Likewise, the electric power consumption is also increased stepwise.

If the pump unit 305 is formed as described above using the combination of the first and second pumps 320 and 321 that have large and small different performance in the different amount of discharged fuel and electric power consumption, it is possible to stepwise supply fuel in accordance with the operating state of the engine by simple control, that is, only the combination of the operation or stop of the pumps. Therefore, it is possible to change the amount of discharged fuel of the pump unit 305 stepwise without performing complicated control and to secure a necessary amount of discharged fuel when needed.

As a result, a pump having a large flow rate does not need to be employed in order to secure the amount “c” of discharged fuel that is needed at the time of a high load such as the full open of a throttle. Further, it is possible to suppress the unnecessary consumption of electric power, which corresponds to the decreased return fuel of the regulator, without generating a large amount of return fuel of the regulator in a low-load range or the like.

In addition, since it is possible to change electric power consumption into an optimal state in accordance with the operating conditions by the combination of the pumps having different electric power consumption, it is possible to suppress electric power consumption and to reduce the size of a generator (ACG). For this reason, it is possible to improve fuel efficiency through the reduction of an electric load.

Meanwhile, a combination of two pumps having different amount of discharged fuel and electric power consumption [are] have been described in the above description, but the number of pumps to be combined may be two or more. For example, if a pump corresponding to a middle load is formed through the combination of two or more pumps that have different performance in the amount of discharged fuel and electric power consumption, it is possible to more accurately control the amount of discharged fuel in a middle-load range. Further, a pump corresponding to a low or middle load may be formed through the combination of a plurality of pumps having the same performance.

Furthermore, the pump unit 305 may not supply fuel to the injectors of the throttle body through the joining common discharge passage 324 unlike in the first and second embodiments, and may supply fuel to the throttle body of the engine including the resting cylinders through a plurality of discharge passages like in the third embodiment.

1-8. (canceled)

9. A fuel supply device that supplies fuel to an engine by a fuel pump disposed in a fuel tank, comprising
a plurality of fuel pumps and
an inlet of each of the fuel pumps is connected to a common fuel filter,
wherein a discharge port of each of the fuel pumps is connected to a common discharge passage and
one pressure regulator is disposed on the common discharge passage,
wherein the plurality of fuel pumps are integrated into a common mounting seat that is mounted on a bottom portion of the fuel tank to form a single pump unit,
wherein the pump unit includes one pressure regulator and one fuel filter common to the fuel pumps.

10. The fuel supply device according to claims 9,
wherein fuel is supplied to a plurality of injectors from the pump unit.

11. The fuel supply device according to claim 9,
wherein the fuel pumps of the pump unit each have a cylindrical shape, are disposed in parallel so that axes of the fuel pumps are parallel to each other, and are fixed to the mounting seat.

12. A fuel supply device that supplies fuel to an engine by a fuel pump disposed in a fuel tank,
wherein the at least one fuel pump comprises a plurality of fuel pumps,
the plurality of fuel pumps includes first and second fuel pumps that have different amount of discharged fuel and electric power consumption and
in accordance with operating conditions of the engine, an operating state is switched to any one of
a first operating state where the first fuel pump is operated and the second fuel pump is rested to supply fuel to the engine,
a second operating state where the second fuel pump is operated and the first fuel pump is rested to supply fuel to the engine and
a third operating state where the first and second fuel pumps are operated to supply fuel to the engine, so that fuel is supplied to the engine.

13. The fuel supply device according to claim 12,
wherein the first and second fuel pumps of the pump unit each have a cylindrical shape, are disposed in parallel so that axes of the fuel pumps are parallel to each other, and are fixed and integrated to a common mounting seat to form a single pump unit and
the mounting seat is detachably mounted on a bottom portion of the fuel tank.

14. The fuel supply device according to claim 9, the engine comprises a plurality of cylinder,
wherein the respective fuel pumps are operated or rested in accordance with an operation or a rest of the respective charging cylinder.

15. The fuel supply device according to claim 12, the engine comprises a plurality of cylinder,
wherein the respective fuel pumps are operated or rested in accordance with an operation or a rest of the respective charging cylinder.
